(19) United States
(12) Patent Application Publication
(10) Pub. No.: US 2003/0107479 A1
(43) Pub. Date: Jun. 12, 2003

(54) Vehicle security

(76) Inventor: Tom Evans, Ceredigion (GB)

Correspondence Address: Weiss & Weiss, Suite 305, 500 Old Country Road, Garden City, NY, 11530, US

(21) Appl. No.: 10/203,236

(22) PCT Filed: Feb. 1, 2001
(86) PCT No.: PCT/GB01/00390

(30) Foreign Application Priority Data
Feb. 5, 2000 (GB) 0002598.1
Oct. 13, 2000 (GB) 0025093.6

(51) Int. Cl. B60R 25/10

(52) U.S. Cl. 340/427

(57) ABSTRACT

An alarm system (10) for use in a vehicle such as a bicycle, motorbike, quad bike or the like, comprising a base (12) on which is mounted a vibration sensor (14), a microprocessor (16) and a sounder (18). A power supply (20), consisting of two rechargeable batteries (22) are connected to the base (12) to provide power to the vibration sensor (14), the microprocessor (16) and the sounder (18). The alarm system (10) can be placed into the handlebar (24, FIG. 2) of a bicycle or the like by removing the handgrip (26, FIG. 2) and inserting the entire system (including the power supply 20) into the open end of the tubular handlebar.

The present invention relates to vehicle security, particularly security of two wheeled vehicles, such as, most especially, bicycles, quad bicycles, motorcycles and the like.

Security for vehicles such as bicycles, quad bikes, motor bikes and the like has long been a problem. Several locking devices, such as chain locks and the like are widely used to shackle a bicycle to an immovable structure such as a set of railings. However, such locks can be cumbersome to transport and may damage the paint or bodywork of the bicycle. Further, they are of no use if there is no suitable immovable structure available at the location where the bicycle is required to be left, and, in any event, they can be removed by cutting with bolt cutters or the like. Another known type of lock is used to prevent movement of one or both bicyle wheels. However, such a lock does not prevent the bicycle from being physically lifted and carried away.

It is known to provide an alarm unit for a bicycle, which unit comprises a sensor, for example a tilt or vibration sensor, which causes activation of a sounder or other alarm means in response to movement. The sounder, sensor and associated control means and power supply are housed in a casing which is bolted onto the frame of a bicycle. Once the alarm unit is armed, if the bicycle is moved, the sounder is actuated to alert the owner and/or passers-by that the bicycle is being tampered with, as well as to act as a deterrent.

However, such a unit is fairly large and, because it is bolted onto the bicycle frame, is highly visible and accessible, such that it is relatively easily removed, damaged or destroyed.

We have now devised an arrangement which overcomes the problems outlined above.

According to a first aspect of the invention, there is provided an alarm system for use in a vehicle such as a bicycle, motorbike, quad bike or the like, the alarm system comprising:

(i) sensing means for sensoring unauthorised disturbance of the vehicle; and

(ii) warning means, operative in response to an unauthorised disturbance of the vehicle sensed by the sensing means;

said sensing means and said warning means being capable of being mounted or otherwise fixed or held within the body of the vehicle, when in use.

The first aspect of the present invention extends to a vehicle, such as a bicycle, motorbike, quad bike, or the like, having an alarm system as defined above mounted, fixed or otherwise held within the body thereof.

For the avoidance of doubt, the body of the vehicle is intended to encompass, amongst other things, the vehicle frame, the handlebars, the seat or any other standard component thereof. In addition, it will be understood that the alarm system of the first aspect of the present invention is capable of being mounted, fixed or otherwise held within the body of other items, such as a chain lock, a disc lock (for a vehicle having disc brakes) or “D” shackle lock, and the first aspect of the invention is intended to encompass this possibility.

The alarm system preferably comprises control means, preferably micro-processor based, for controlling the operation of the warning means. The control means is preferably also capable of being mounted, fixed or otherwise held within the main body of the vehicle.

The warning means is preferably audible. Additionally, visible (or other) warning means may be provided, possibly externally of the main body of the vehicle. The sensing means is preferably a movement sensor, preferably a vibration or tilt sensor. Alternatively, the sensing means may be a shock sensor or, particularly in an embodiment of the first aspect of the invention intended to be mounted, fixed or otherwise held within the seat, or handlebars, of a vehicle, the sensing means might be pressure sensing means, such as pressure pads, housed just under the surface of the seat, or under or within the handle bar grips.

The alarm system of the first aspect of the invention preferably includes means, beneficially in the control means, for switching the alarm system between an active mode and an inactive mode. Such means may be actuated by a jack plug, a key, preferably coded, remote control, transponder, magnetic device or other suitable means. When the alarm system is in active mode or “armed”, the control means is preferably arranged to cause the warning means to be activated at least once, preferably briefly (such as one or more “pips” from a sounder) to indicate that the system has been successfully switched on. The control means may be similarly arranged to activate the warning means when the alarm system is switched off. In addition, as an initial response to an output signal from the sensing means indicating possible unauthorised tampering with the vehicle, the control means may be arranged to activate the warning means one or more times, relatively briefly as an initial warning, and then activate the warning means continuously if the output signal from the sensing means persists or re-occurs (possibly within a predetermined period of time after which the alarm might be reset if no further output signal from the sensing means occurs.

The alarm system may be housed in, or at least linked to, a vehicle support means, such as a stand or the like. Some bicycles and other vehicles are fitted with a hydraulic braking system, in which case, the alarm system may be linked to this. The alarm system may also include or be linked to means for compressing the vehicle brakes (in all types of vehicle) either in response to unauthorised tampering or simply for the entire time that the alarm system is switched on.

A preferred embodiment of the first aspect of the invention provides an alarm system comprising in or on a single unit:

(i) sensing means for sensing unauthorised disturbance of the vehicle;

(ii) warning means operating in response to an unauthorised disturbance of the vehicle sensed by the sensing means;

(iii) control means for controlling operation of the warning means; and

(iv) a power supply;

the single unit being capable of being mounted, fixed or otherwise held within the main body of the vehicle.

The power supply is preferably one or more batteries, preferably rechargeable (via a mains power supply, solar power, or the like), and the unit (including the battery supply) is beneficially substantially enclosed within a (preferably waterproof) housing.

According to a second aspect, the present invention provides apparatus comprising:

(a) a support arrangement mounted on a vehicle and powered to change configuration or orientation between a stowed condition and a ground engaging condition, the support arrangement supporting the vehicle in an upright position when in the ground engaging condition; and,

(b) an alarm arrangement being operable in an active mode when the vehicle is supported by the support arrangement in the upright position, the alarm being triggered to output an alarm upon displacement of the vehicle.

It is preferred that operation of the support arrangement and the alarm arrangement is operatively linked, desirably such that the alarm arrangement is inhibited from being set in active mode substantially until the support arrangement is in the ground engaging condition.

It is preferred that the support arrangement comprises a fluid power actuator for moving between the stowed and ground engaging conditions. The fluid power actuator preferably comprises hydraulic or pneumatically actuated means.

In moving from the stowed condition to the ground engaging, support condition, the support arrangement may cause the vehicle to be lifted (for example one wheel may be lifted clear of the ground surface). Unauthorised taking of the vehicle will require the vehicle to be raised further (for wheeling on rear or forward wheels only) or lowered (by overcoming the support arrangement) for wheeling normally. Any such raising or lowering will cause the alarm to operate.

The alarm arrangement preferably comprises a sensor arranged to detect variation in the vehicle orientation and/or motion of the vehicle from the raised position. A motion sensor, tilt sensor or the like may therefore be utilised to detect the required change in orientation or motion of the vehicle.

The alarm is preferably arranged to be set to the active mode either manually (when the vehicle is in the supported position) or automatically when the, support position is reached. The lifting arrangement and alarm arrangement are therefore beneficially coupled to ensure that the alarm is not set to the active mode until the raised position is reached and the vehicle is supported by the support arrangement.

Alternatively, the alarm may be set to the active mode manually when the support arrangement is in the ground engaging condition supporting the vehicle. Key (or keypad and code) operation or the like may be used to achieve this.

It is preferred that the support arrangement is caused to be actuated in response to a control stimulus which may, for example, be operation of the vehicle ignition key, (or other keyed operation) to automatically alter the support arrangement configuration or position between the stowed and ground engaging (lifting) conditions.

In use, the vehicle, which is typically a motorcycle, is fitted with an hydraulically actuated stand and an alarm. The stand is, in accordance with the invention, operatively coupled to the alarm and movable from a stowed position to a ground engaging support position in which the motorcycle is supported (typically with a front wheel raised from the ground).

The motorcycle is dismounted by the user and control of the hydraulic lift is actuated to cause the stand to raise the vehicle from its in use position to a supported position resting on the stand. When the supported position is reached, a positional sensor on the hydraulic lifting arrangement triggers the vehicle alarm to be set in an active mode.

As mentioned above, the alarm may, for example, include a tilt switch which is arranged to trigger the alarm to output audible and/or visual alarm signals (or other alarm signals, for example, radio frequency signals) in response to the vehicle being moved beyond a predetermined threshold distance from the supported position (e.g. as a result of tilting the motorcycle upwardly to raise the motorcycle support stand from engagement with the ground).

The powered lift of the lifting arrangement/stand greatly aids the ease of parking the vehicle and can, in itself, provide means of setting the alarm when the vehicle is appropriately supported.

According to a third aspect, the invention provides an alarm system for a vehicle, particularly a bicycle, quad bike, motorcycle or the like, wherein an alarm is operatively connected to a seat of the vehicle and arranged to be actuated to produce an alarm when a body is positioned on the seat.

The alarm may be audible or visual or both. The alarm may be triggered to operate by means of a pressure/weight sensor, photo-sensor or other sensor or switch arranged to be operated or switched by the presence of the body on the seat.

The alarm serves to discourage passers by from sitting on the vehicle seat (whether or not intending to steal the vehicle); such behaviour is known to be irritating to vehicle owners, particularly motorcycle owners.

Exemplary embodiments of the invention will now be described with reference to the accompanying drawings, in which:

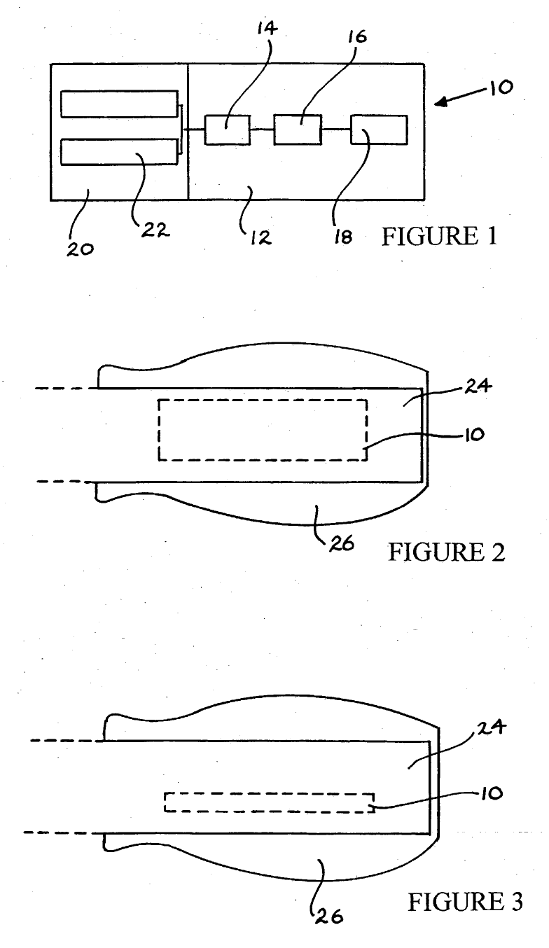

FIG. 1 is a schematic simplified diagram of an exemplary embodiment of an alarm system ac cording to the first aspect of the present invention;

FIG. 2 is a schematic plan view of a bicycle handlebar incorporating the alarm system of FIG. 1;

FIG. 3 is a schematic plan view of the bicycle handlebar of FIG. 2;

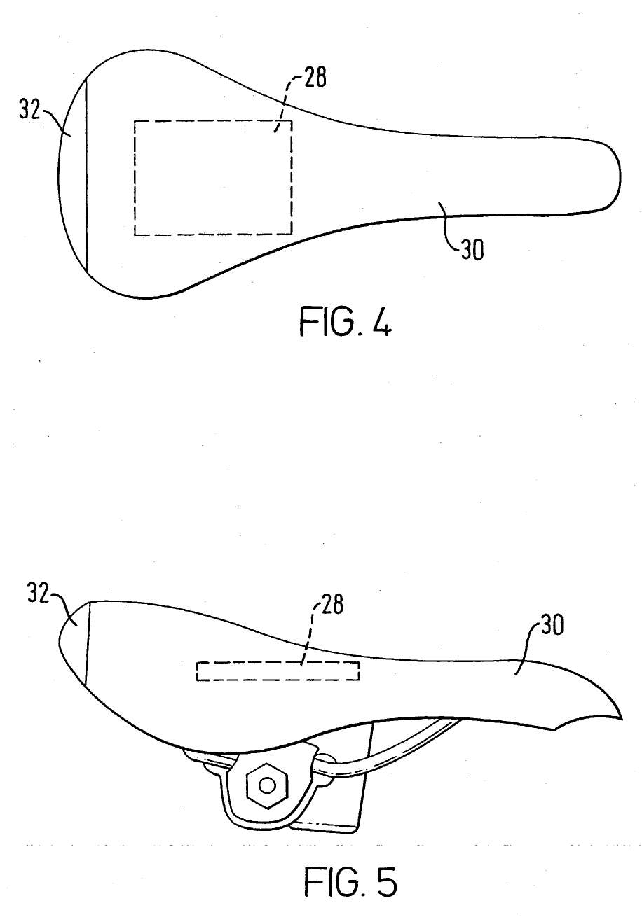

FIG. 4 is a schematic plan view of a bicycle seat incorporating an alarm system according to another exemplary embodiment of the first aspect of the present invention;

FIG. 5 is a schematic side view of the bicycle seat of FIG. 4;

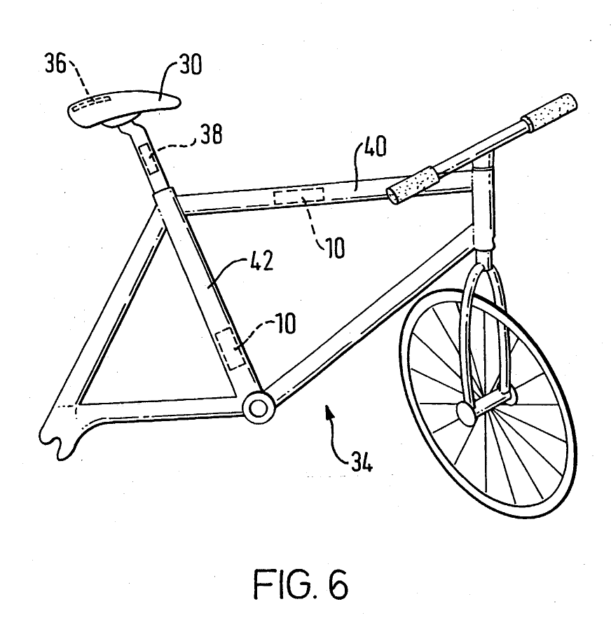

FIG. 6 is a schematic diagram of a bicycle illustrating possible locations within the body for the alarm system of the first aspect of the invention;

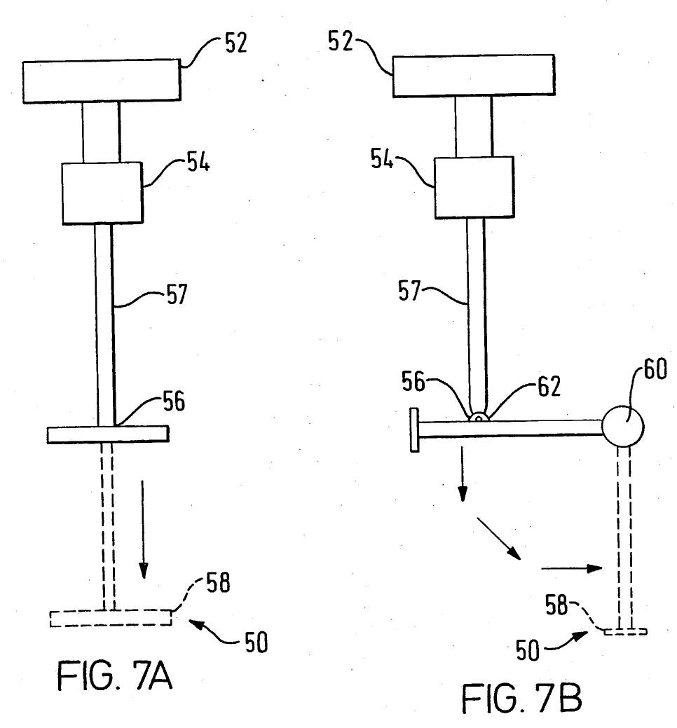

FIG. 7A is a schematic diagram of a first exemplary embodiment of a support arrangement for use in an exemplary embodiment of the apparatus of the second aspect of the invention; and

FIG. 7B is a schematic diagram of a second exemplary embodiment of a support arrangement for use in an exemplary embodiment of the apparatus of the second aspect of the invention.

Referring to FIG. 1 of the drawings, a simplified exemplary embodiment of an alarm system 10 according to the first aspect of the invention comprises a base 12 on which is mounted a vibration sensor 14, a microprocessor 16 and a sounder 18. A power supply 20, consisting of two, preferably but not necessarily, rechargeable batteries 22, are connected to the base 12 to provide power to the vibration sensor 14, the microprocessor 16 and the sounder 18.

Referring to FIGS. 2 and 3 of the drawings, the alarm system of FIG. 1 can be placed into the handlebar 24 of a bicycle or the like by removing the handgrip 26 and inserting the entire system (including the power supply 20) into the open end of the tubular handlebar 24. Once the handgrip 26 is replaced, the alarm system 10 is concealed from view and protected from moisture and other damage. The alarm system 10 (possibly including the power supply 20) may be enclosed by a waterproof housing (not shown) for additional protection.

In use, the alarm system 10 is set to active mode by means of a jack plug or key (preferably coded) inserted into a socket (not shown) provided externally of the bicycle, or by remote control, transponder, some type of magnetic device, or other suitable means operable by the user. When the system 10 is first set to active mode, it is arranged to indicate to the user if the batteries 22 are running low, the system 10 may be arranged to actuate the sounder 18 for this purpose, perhaps to give a single “pip” if the batteries 22 are charged and a plurality of “pips” if the batteries 22 are low on charge.

Once the alarm system 10 is in active mode, if movement is sensed by the vibration sensor 14, the system 10 is arranged to actuate the sounder 18, initially as a warning, perhaps to give one or more “pips”. If no further movement is sensed within a predetermined period of time, the alarm system 10 is reset. If however, further movement is sensed within that predetermined time following the warning, the sounder 18 is actuated continuously, at least for a relatively long period of time, say 100 decibels.

When the alarm system 10 is switched to the inactive mode (once again, by means of a jack plug, key, remote control, transponder, magnetic device etc), if the alarm has sounded during the preceding active period, this is indicated to the user by one or more “pips” from the sounder.

Referring to FIGS. 4 and 5 of the drawings, another exemplary embodiment of the alarm system 28 according to the first aspect of the invention comprises a circuit similar in most respects to the arrangement shown in FIG. 1, but including a pressure sensor, e.g. one or more pressure pads (not shown), in addition to or as an alternative to the vibration sensor 14. The alarm system 28 is mounted within a bicycle seat 30, as shown, and operates in a manner similar to that described with reference to FIGS. 1 to 3, except that the sensor senses pressure (if someone sits on the seat 30, for example) as well as or instead of movement.

The alarm system 28 may be linked to additional visible warning means, such as one or more LED's 32 mounted at the rear of seat 30.

In the case of the alarm system 10 of FIGS. 1 to 3 and the alarm system 28 of FIGS. 4 and 5, the power supply the handgrips 26. Another example of a suitable location for some or all of the components of the alarm system of the first aspect of the invention, would be the wheel forks 44 (at 46). Several other suitable locations within the body of the bicycle 34 for positioning one or more of the components of an alarm system according to the first aspect of the invention are envisaged.

Yet another exemplary embodiment of the first aspect of the present invention is for use with children's pushchairs and the like. In a preferred such exemplary embodiments, the alarm system includes an alarm, preferably audible within the frame of a child's pushchair or the like. In addition, pressure sensing system described with reference to FIGS. 4 and 5 of the drawings is reversed, so that the alarm is actuated when a child is removed from the vehicle. For the sensing means, the microprocessor and the sounder may comprise one or more batteries, preferably rechargeable, for example by connecting to a mains power supply (via, for example, a jack plug or the like and/or by solar power.

Referring to FIG. 6 of the drawings, it is envisaged that the alarm system of the first aspect of the invention can be incorporated in several different locations within the body of a bicycle 34. For example, pressure pads 36 may be housed just under the seat 30, and linked to a control and warning device 36 housed in the seat post 38. Alternatively (or in addition) an alarm system 10 like the one described with reference to FIGS. 1 to 3 might be held within the bar 40 or any other part of the bicycle frame 42. As explained with reference to FIGS. 1 to 3, the alarm system 10 may be held within the handlebars 24. Alternatively (or in addition) pressure pads (not shown) may be located just under the hand grips 26.

Referring to FIGS. 7A and 7B of the drawings, a support arrangement 50 suitable for use in apparatus according to an exemplary embodiment of the invention comprises a tank 52 supplying a hydraulic pump 54 which actuates a telescopic ram 56 via a pipe 57 (which may be braided and flexible). Operation of the telescopic ram 56 causes a stand 58 to a selectively lowered to engage the ground, or raised from the ground.

In the embodiment of the support arrangement shown in FIG. 7A, the stand 58 is in line with the telescopic ram 56, and movement of the stand 58 is accordingly substantially vertical, as shown. In the embodiment shown in FIG. 7B, the stand 58 is connected at one end to the swivel joint 60. Further, the telescopic ram 56 is connected to the stand 58 at a point close to the other end via another swivel joint 62. Vertical movement of the ram 56 causes the stand 58 to rotate about the swivel joint 60, and is thus lowered to the ground, and raised, as shown.

Specific embodiments of the various aspects of the invention have been described by way of examples only and it will be apparent to persons skilled in the art that variations and modifications can be made without departing from the scope of the invention.

1. An alarm system for use in a vehicle such as a bicycle, motorbike, quad bike or the like, the alarm system comprising:
i) sensing means for sensoring unauthorised disturbance of the vehicle; and
ii) warning means, operative in response to an unauthorised disturbance of the vehicle sensed by the sensing means;
said sensing means and said warning means being capable of being mounted or otherwise fixed or held within the body of the vehicle, when in use.

2. An alarm system according to claim 1, comprising control means, preferably micro-processor based, for controlling the operation of the warning means.

3. An alarm system according to claim 2, wherein said control means is capable of being mounted, fixed or otherwise held within the main body of the vehicle.

4. An alarm system according to any one of the preceding claims, wherein said warning means is audible.

5. An alarm system according to any one of the preceding claims, wherein said sensing means comprises a movement sensor, preferably a vibration or tilt sensor.

6. An alarm system according to any one of claims 1 to 4, wherein said sensing means comprises a shock sensor and/or pressure sensing means, such as pressure pads.

7. An alarm system according to any one of the preceding claims, comprising means for switching the alarm system between an active mode and an inactive mode.

8. An alarm system according to claim 7, wherein said switching means is actuatable by a jack plug, a key, preferably coded, remote control, transponder, magnetic device or other suitable means.

9. An alarm system according to any one of the preceding claims, housed in, or at least linked to, a vehicle support means or vehicle locking means, such as a stand or chain lock or the like.

10. An alarm system according to any one of the preceding claims, including or linked to means for compressing the vehicle brakes, either in response to unauthorised tampering or simply for the entire time that the alarm system is switched on.

11. A vehicle having an alarm system according to any one of the preceding claims, mounted, fixed or otherwise held within the body thereof.

12. An alarm system comprising in or on a single unit:
i) sensing means for sensing unauthorised disturbance of the vehicle;
ii) warning means operating in response to an unauthorised disturbance of the vehicle sensed by the sensing means;
iii) control means for controlling operation of the warning means; and
iv) a power supply;
the single unit being capable of being mounted, fixed or otherwise held within the main body of the vehicle.

13. An alarm system according to claim 12, wherein the power supply comprises one or more batteries, preferably rechargeable (via a mains power supply, solar power, or the like).

14. An alarm system according to claim 12 or claim 13, wherein said unit is substantially enclosed within a (preferably waterproof) housing.

15. Apparatus comprising:
i) a support arrangement mounted on a vehicle and powered to change configuration or orientation between a stowed condition and a ground engaging condition, the support arrangement supporting the vehicle in an upright position when in the ground engaging condition; and,
ii) an alarm arrangement being operable in an active mode when the vehicle is supported by the support arrangement in the upright position, the alarm being triggered to output an alarm upon displacement of the vehicle.

16. Apparatus according to claim 15, wherein the operation of the support arrangement and the alarm arrangement is operatively linked, desirably such that the alarm arrangement is inhibited from being set in active mode substantially until the support arrangement is in the ground engaging condition.

17. Apparatus according to claim 15 or claim 16, wherein the support arrangement comprises a fluid power actuator for moving between the stowed and ground engaging conditions.

18. Apparatus according to claim 17, wherein the fluid power actuator comprises hydraulic or pneumatically actuated means.

19. Apparatus according to any one of claims 15 to 18, wherein the alarm arrangement comprises a sensor arranged to detect variation in the vehicle orientation and/or motion of the vehicle from the raised position.

20. Apparatus according to claim 19, wherein said sensor comprises a motor sensor or tilt sensor.

21. An alarm system for a vehicle, particularly a bicycle, quad bike, motorcycle or the like, wherein an alarm is operatively connected to a seat of the vehicle and arranged to be actuated to produce an alarm when a body is positioned on the seat.

22. An alarm system according to claim 21, wherein said alarm is audible or visual or both.

23. An alarm system according to claim 21 or claim 22, wherein the alarm is arranged to be triggered to operate by means of a pressure/weight sensor, photo-sensor or other sensor or switch arranged to be operated or switched by the presence of the body on the seat.

24. An alarm system substantially as herein described with reference to the accompanying drawings.
